(19) United States
(12) Patent Application Publication
(10) Pub. No.: US 2012/0077086 A1
(43) Pub. Date: Mar. 29, 2012

(54) SURFACE AGENT HAVING DISCHARGE FUNCTION AND BATTERY USING THE SAME

(76) Inventor: Kuan-Jen Chen, Kaohsiung City (TW)

(21) Appl. No.: 13/314,189

(22) Filed: Dec. 8, 2011

Related U.S. Application Data
(62) Division of application No. 12/554,000, filed on Sep. 4, 2009.

(51) Int. Cl. H01M 4/60

(52) U.S. Cl. 429/212

(57) ABSTRACT

The surface agent contains a grounding layer, two nucleic acid molecular layers, a partitioning grid layer, a silver circuit layer, and two insulating layers. The grounding layer is made of carbon and metallic materials such as aluminum, copper, and is connected to the negative electrode of a rechargeable battery The silver circuit layer is connected to the positive electrode. The nucleic acid molecular layers are positioned between the silver circuit and grounding layers and the partitioning grid layer is sandwiched therebetween. The nucleic acid molecules are produced by mixing ferric oxide extracted from mulberry fruit and acetate. As the ferric oxide is a bad conductor capable of carrying charges, electricity would suffer more loss as it is conducted through the bad conductor. As such, the rechargeable battery could be continuously discharged, and the memory effect is therefore avoided to maintain the rechargeable battery's capacity.

### CROSS-REFERENCE TO RELATED APPLICATIONS

This is a division of pending patent application Ser. No. 12/554,000, filed Sep. 4, 2009.

(a) Technical Field of the Invention

The present invention generally relates to rechargeable batteries, and more particularly to a surface agent capable of causing a rechargeable battery to continuously discharge so as to eliminate the memory effect.

(b) Description of the Prior Art

Portability and compactness have become the major trend of electronic devices. Under this trend, many bulky electronic devices have now become easily portable. For example, the notebook computer is evolved from the desktop computer; the mobile phone is evolved from the household phone set. These portable devices are only powered by their batteries and, as such, batteries begin to play an increasingly vital role to these portable electronic devices.

Currently there are various types of batteries used by the portable electronic devices but most of them are rechargeable batteries such as nickel-metal-hydride (NiMH) batteries, nickel-cadmium (NiCd) batteries, or lithium (Li) batteries. These types of rechargeable batteries have their respective characteristics but all have similar problems such as discharge effect, number of times of charge and discharge, and over-charge/over-discharge, etc. For NiMH and NiCd batteries, they have additional memory effect problem. In general, the operational life of rechargeable batteries is reduced with each charge/discharge and excessive charge/discharge could even damage the batteries. For a fully charged battery, its stored electrical energy would gradually lapse over a period of time even not in use. And, if the battery is frequently charged when it still has substantial amount of stored electrical energy, the capacity of the battery would gradually decrease. As most users do not charge the battery only when its stored electrical energy is completely consumed, the battery is usually charged when there is still some residual electricity left. This will result the so-called memory effect where the battery will lose some capacity for each charge. As the capacity of the battery is getting smaller, the usage time of the battery is shortened as well, thereby reducing the battery's performance.

### SUMMARY OF THE INVENTION

The present invention provides a surface agent having discharge function. The surface agent has a multi-layer structure and contains a grounding layer, two nucleic acid molecular layers, a partitioning grid layer, a silver circuit layer, and two insulating layers. The grounding layer is made of carbon and metallic materials such as aluminum, copper, and is connected to the negative electrode of a rechargeable battery. The silver circuit layer is connected to the positive electrode of the rechargeable battery. The nucleic acid molecular layers are positioned between the silver circuit layer and the grounding layer and the partitioning grid layer is sandwiched between the nucleic acid molecular layers to prevent the positive and negative electrodes of the rechargeable battery from direct contacting with each other. The nucleic acid molecules of the nucleic acid molecular layers are produced by mixing ferric oxide extracted from mulberry fruit and acetate.

The present invention also provides a rechargeable battery having discharge function whose positive and negative electrodes are connected to the silver circuit layer and grounding layer of the surface agent, respectively. As the ferric oxide in the nucleic acid molecular layers is a bad conductor capable of carrying charges, electricity of the rechargeable battery would suffer more loss as it is conducted through the bad conductor. As such, the rechargeable battery could be effectively and continuously discharged, the memory effect is therefore avoided and the rechargeable battery's capacity could be effectively maintained.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the structure of a surface agent according to an embodiment of the present invention.

FIG. 2 is a schematic diagram showing the production of nucleic acid molecules used by the present invention.

FIG. 3 is a schematic diagram showing the application of the surface agent of FIG. 1 to a circuit board.

FIG. 4 is a schematic diagram showing an integrated circuit adopting the surface agent of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

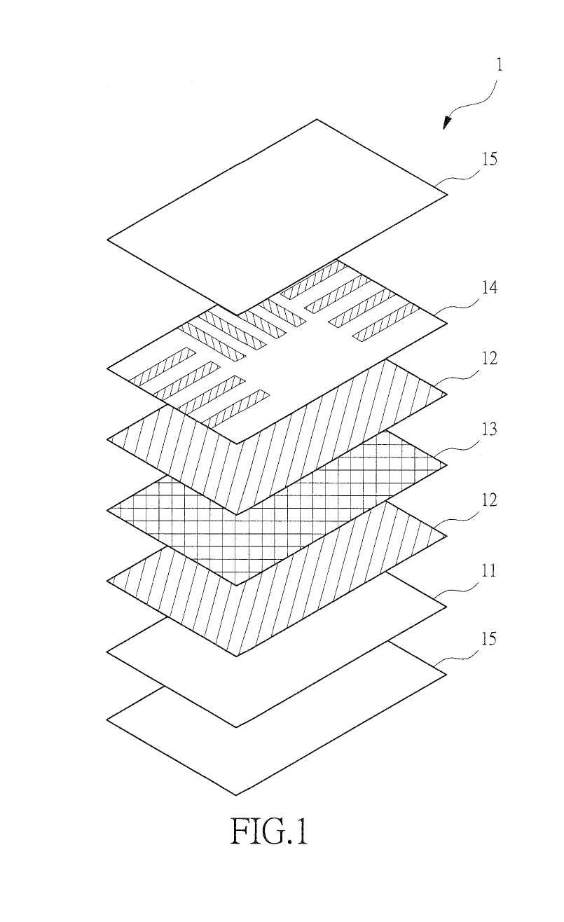

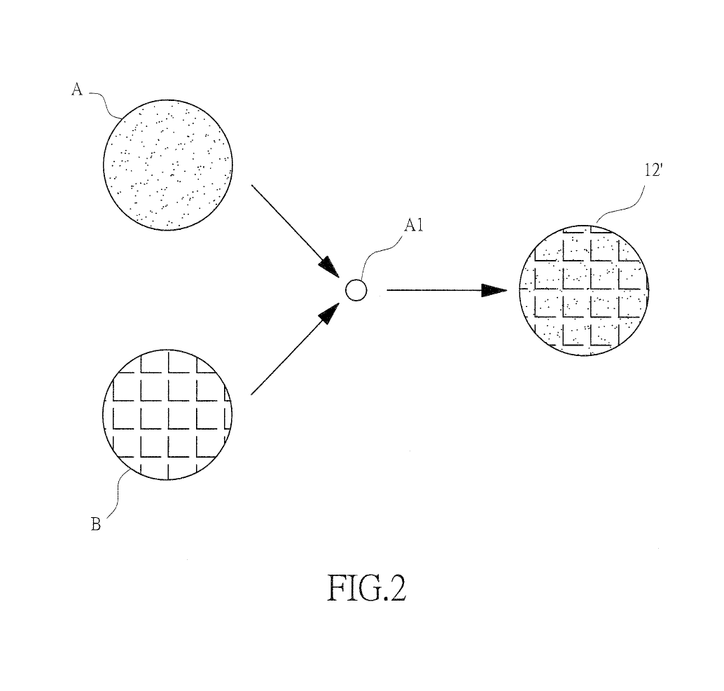

As shown in FIGS. 1 and 2, a surface agent 1 according to an embodiment of the present invention contains a grounding layer 11, two nucleic acid molecular layers 12, a partitioning grid layer 13, a silver circuit layer 14, and two insulating layers 15.

The grounding layer 11 is positioned beneath the nucleic acid molecular layers 12 and is made of carbon and metallic materials such as aluminum, copper. The grounding layer 11 is connected to the negative electrode of a rechargeable battery.

The nucleic acid molecular layers 12 are positioned above the grounding layer 11. As shown in FIG. 2, the nucleic acid molecules 12′ are produced by mixing ferric oxide A1 extracted from mulberry fruit A and acetate B. Ferric oxide A1 is a bad conductor capable of carrying charges.

The partitioning grid layer 13 is sandwiched between the two nucleic acid molecular layers 12 to prevent the positive and negative electrodes of the rechargeable battery from direct contacting with each other.

The silver circuit layer 14 is positioned above the nucleic acid molecular layers 12 and is connected to the positive electrode of the rechargeable battery.

The insulating layers 15 are positioned above the silver circuit layer 14 and beneath the grounding layer 11, respectively.

The surface agent 1 as described above has a small electrical power (about 0.75 volt).

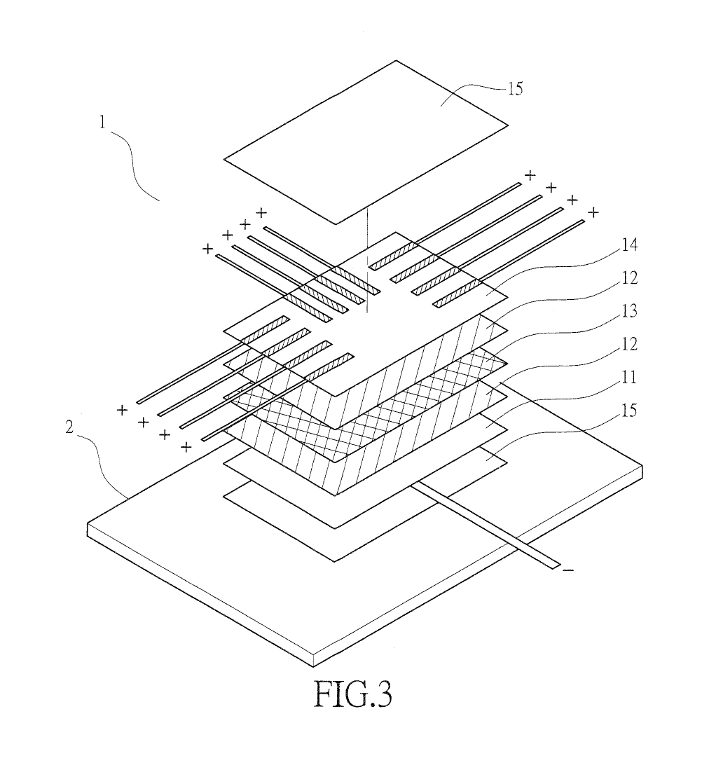

As shown in FIG. 3, the surface agent 1 is applied to a circuit board 2 of the rechargeable battery by screen printing and manufacturing method of integrated circuits so that the grounding layer 11, the nucleic acid molecular layers 12, the partitioning grid layer 13, the silver circuit layer 14, and the insulating layers 15 are layer-by-layer formed on the circuit board 2. The positive electrode of the rechargeable battery is connected to the silver circuit layer 14 while the negative electrode is connected to the grounding layer 11. As the nucleic acid molecular layers 12 are positioned between the silver circuit layer 14 and the grounding layer 11, and as the ferric oxide A1 in the nucleic acid molecular layers 12 is a bad conductor capable of carrying charges, electricity of the rechargeable battery would suffer more loss as it is conducted through the bad conductor so as to achieve the purpose of discharge. In addition, the surface agent 1 could be connected to multiple rechargeable batteries and, once these rechargeable batteries are conducted, they are discharged so as to eliminate the memory effect and to maintain the capacity of these rechargeable batteries.

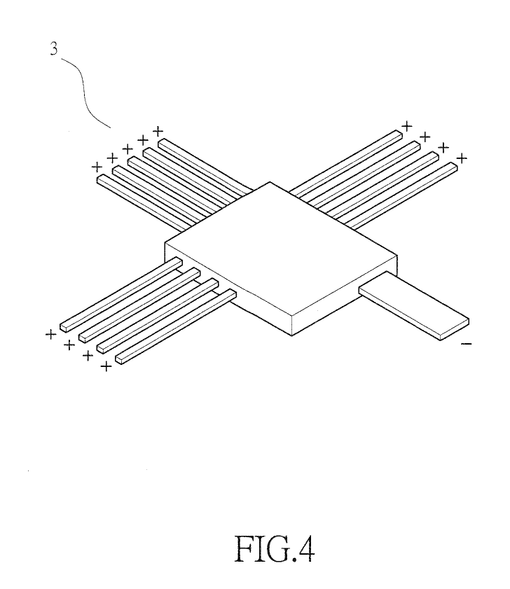

As shown in FIG. 4, the surface agent 1 of the invention could be applied to the circuit board 2 of an integrated circuit 3 by screen printing. The form factor of the integrated circuit 3 therefore could be reduced for wider applicability and more flexible configuration.

In summary, the surface agent 1 of the present invention contains a grounding layer 11, two nucleic acid molecular layers 12, a partitioning grid layer 13, a silver circuit layer 14, and two insulating layers 15. The nucleic acid molecules 12′ of the nucleic acid molecular layers 12 are produced by mixing ferric oxide A1 extracted from mulberry fruit A and acetate B. By the ferric oxide A1's being bad conductor and capable of carrying charges, a rechargeable battery could be effectively and continuously discharged as electricity of the rechargeable battery would suffer more loss when it is conducted through the bad conductor. The memory effect is therefore avoided and the rechargeable battery's capacity could be effectively maintained.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A battery comprising a surface agent, said surface agent comprising a grounding layer, two nucleic acid molecular layers, a partitioning grid layer, and a silver circuit layer, wherein a negative electrode of said battery is connected to said grounding layer; and a positive electrode of said battery is connected to said sliver circuit layer.

2. The battery according to claim 1, wherein said surface agent carries a small amount of electricity.

3. The battery according to claim 2, wherein said small amount of electricity is substantially 0.75 volt.

4. The battery according to claim 1, wherein nucleic acid molecules of said nucleic acid molecular layers are produced by mixing ferric oxide extracted from mulberry fruit and acetate.

5. The battery according to claim 1, wherein said grounding layer is made at least of carbon, aluminum, and copper.

6. The battery according to claim 1, wherein an insulating layer is positioned above said sliver circuit layer.

7. The battery according to claim 1, wherein an insulating layer is positioned beneath said grounding layer.

8. The battery according to claim 1, wherein there are multiple sets of said battery.
